(19) United States
(12) Patent Application Publication
(10) Pub. No.: US 2008/0133410 A1
(43) Pub. Date: Jun. 5, 2008

(54) Method and System for Selecting Electronic Payment of Vendors Through an Automated Remittance Delivery System

(76) Inventor: Lynn Y. Shimada, Murray, UT (US)

Correspondence Address: Michael F. Krieger;KIRTON & McCONKIE, P. O. Box 45120, Salt Lake City, UT, 84145-0120, US

(21) Appl. No.: 11/952,859

(22) Filed: Dec. 7, 2007

Related U.S. Application Data
(63) Continuation of application No. 10/171,450, filed on Jun. 13, 2002, now abandoned.
Application No. 10/171,450 is a division of application No. 09/345,820, filed on Jun. 30, 1999.
(60) Provisional application No. 60/092,329, filed on Jul. 9, 1998.
(60) Provisional application No. 60/091,416, filed on Jul. 1, 1998.

(51) Int. Cl. G06Q 40/00

(52) U.S. Cl. 705/40

(57) ABSTRACT

An electronic payment system and method for determining which payment method is to be employed for each vendor specified in the output of a commercial accounting software application. The system retrieves from the accounting software application payment information specifying specific vendors to be paid and consults with an electronic payment-capable vendor database to determine if a specific vendor listed for payment is capable of receiving electronic payment. When such a vendor is listed, the system compatibility interfaces with an electronic payment process center for the routing of the electronic payment through a financial institution and banking network. Additionally, a user is enabled to make an electronic payment to a vendor that is not capable of receiving an electronic payment by employing an electronic payment process center to generate a printed check at its own site for dispatch to the vendor without requiring the user to generate a printed check.

### RELATED APPLICATIONS

This application is a continuation of and claims priority to prior U.S. application Ser. No. 10/171,450, filed Jun. 13, 2002 and entitled “Method and System for Selecting Electronic Payment of Vendors Through an Automated Remittance Delivery System,” which is a divisional application of and claims priority to prior U.S. application Ser. No. 09/345,820, filed Jun. 30, 1999 entitled “Method and Software Article for Selecting Electronic Payment of Vendors in an Automated Payment Environment,” which claims priority to provisional application Ser. No. 60/092,329 which was filed on Jul. 9, 1998 and is entitled METHOD AND SOFTWARE ARTICLE FOR SELECTING ELECTRONIC PAYMENT OF VENDORS IN AN AUTOMATED PAYMENT ENVIRONMENT, and also to provisional application Ser. No. 60/091,416 which was filed on Jul. 1, 1998 and is entitled the same. All the above-identified applications are incorporated herein by specific reference.

### BACKGROUND OF THE INVENTION

1. The Field of the Invention

The present invention relates generally to electronic payment systems. More specifically, the present invention relates to methods and computer executable instructions for improving payment options available to a user of an electronic payment-capable computer program. Even more specifically, the present invention relates to permitting a user of an electronic payment system to verify and reassign vendors as either electronic paid vendors or traditional draft remunerated vendors.

2. The Relevant Technology

Accounting applications have long allowed a user to automate accounting procedures using the use of a software application. Many commercial software applications have been developed specifically for accounting purposes and are largely commercially available.

While such commercially available software applications facilitate the performance of accounting procedures, one such accounting procedure that has been less than fully developed is that of the accounts payable procedure of physically exchanging funds with a user's vendor. While such commercial applications have been capable of generating a database specifying accounts payable specifics, accounting applications have typically not taken the next step of assisting a user in specifying and implementing accounts payable directives.

Thus, what is needed is a method and application for compatibly interacting with accounting applications to take the data from the accounts payable database thereby facilitating the payment exchange between a user and a vendor. Furthermore, it is also desirous to be able to provide payment to a vendor in an electronic, as opposed to a physical check draft.

### OBJECTS AND SUMMARY OF THE INVENTION

It is, therefore, an object of the present invention to provide a method for determining which of a plurality of payment methods is to be employed for a particular vendor that is to be paid.

It is another object of the present invention to provide software that facilitates the improved method of determining a type of payment to be employed for a specific vendor by compatibly interacting with already established accounting applications.

It is a further object of the present invention to provide a method and application for determining which of a plurality of payment methods including traditional check drafting and electronic payment methods.

In accordance with the invention as embodied and broadly described herein, the foregoing and other objects are achieved by providing computer software and methods for determining which of a plurality of payment methods is to be employed for at least one vendor to be paid. It is a feature of the present invention to provide methods in an application to enable a user to employ a variety of payment systems including an electronic payment process, regardless of a particular accounting system employed. In the present invention, accounts payable output data stored in an accounts payable database generated by an accounting application may be sent directly to the method and application of the present invention for selection of either electronic payment or payment through traditional check drafting processes. In addition, the present invention also enables a user to electronically send “checks” to vendors who cannot receive electronic transfers but may receive payment by employing a third-party such as a service center which generates a typical check draft. Additionally, it is an object of the present invention to provide a unique vendor name or identifier matching algorithm that retrieves a preferred payment method identifier corresponding to the vendor's database identifier or when the vendor identifier is not exactly matched within the accounts payable database, the present invention phonetically matches the specified vendor identifier with an entry in the vendor database. Additionally, the present invention enables a user to select specific vendors to receive payments and to establish or setup those vendors immediately.

The method and system of the present invention provides a user with the ability to pay vendors electronically, regardless of whether the vendors have the technology to receive electronic payments. In a particular embodiment of the present invention, accounts payable checks or drafts may be sent electronically. For example, information that usually be placed on a check and its stub may be sent to a processing center by the application of the present invention through a transceiver such as a modem. Once the processing center receives the check batch, either an electronic bank transfer is made or an actual check may be printed and sent to the designated vendor. The user receives from the processing center a regular confirmation of the completed transactions. In such an embodiment, a vendor does not need to be in possession of any special equipment to receive the payment. One of the primary benefits of the present invention is its ability to capture or utilize data placed within an accounts payable database that is generated by traditional accounting software.

These and other objects and features of the present invention will become more fully apparent from the following description and appended claims, or may be learned by the practice of the invention as set forth herein after.

### BRIEF DESCRIPTION OF THE DRAWINGS

In order to more fully understand the manner in which the above-recited and other advantages and objects of the invention are obtained, a more particular description of the invention will be rendered by reference to specific embodiments thereof which are illustrated in the appended drawings. Understanding that these drawings depict only typical embodiments of the invention and are not therefore to be considered to be limiting of its scope, the invention in its presently understood best mode for making and using the same will be described and explained with additional specificity and detail through the use of the accompanying drawings in which:

FIG. 1 is a simplified block diagram of the components utilized in the present invention that facilitate the electronic payment of accounts, in accordance with a preferred embodiment of the present invention;

FIG. 2 is a flow chart for determining which of a plurality of payment methods is to be employed, in accordance with the preferred embodiment of the present invention;

FIG. 3 is a simplified flow diagram illustrating the flow of a payment through the payment system, in accordance with a preferred embodiment of the present invention; and

FIG. 4 is an illustration of a vendor selection screen specifying vendors as receiving payment either through a printed check technique or through an electronic payment technique, in accordance with a preferred embodiment of a present invention.

### DETAILED DESCRIPTION OF THE PREFERRED EMBODIMENTS

The present invention provides a method and a system whereby a user may enter the domain of electronic payment regardless of the accounting system employed by the user. That is to say, output from an accounting application may be sent directly to the present invention for electronic payment or alternatively for payment through the use of a generated paper check. In addition, the present invention enables a user to send electronic checks to a vendor who cannot receive them currently through the use of a third party such as a service center which ultimately generates and sends a paper check to the vendor. Furthermore, through the present invention's vendor name matching algorithm, the user may choose vendors at print-time to receive payments, and set those vendors up on the system immediately.

The present invention enables a user to have the ability to pay vendors electronically, regardless of whether or not they have the technology to receive electronic payment. Such an implementation enables the user to save both time and money and provides additional flexibility and control over the management of funds. Additionally, a user typically perceives a reduction in cost through not having to internally process printed checks but retaining the flexibility in paying through either electronic methods or through the use of cutting a paper check.

The present invention may be employed as an extension to an existing check printing application by extending the payment capability to include electronic payment. Information that is traditionally placed on the check stub may be electronically sent to a processing center by the present invention via modem. It should be pointed out that prior to invoking the use of a processing center, an account number must be established with the processing center for cooperatively issuing electronic payments. Once the a processing center receives a request for a check batch, either an electronic bank transfer is made or an actual check is printed and sent to the specified vendor. An acknowledgement is thereafter returned to the user signifying the completed transaction on a regular basis. Therefore, the present invention provides a means whereby the vendor does not need to have any special equipment to receive a payment, even a payment in electronic form.

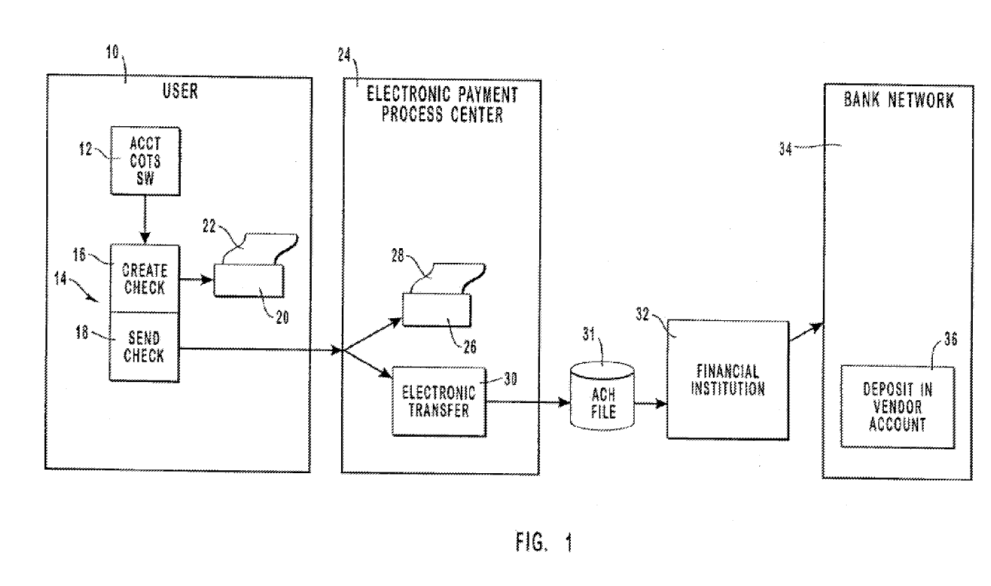

FIG. 1 is a simplified diagram of a high level overview of the major components of a payment process. A user 10 through the use of an accounting application may produce checks or payment to vendors. In the present invention, a determination is made as to whether the payment will be made electronically through a processing center or through the use of a check printed by the user (i.e., on a desktop laser printer). A processing center 24 receives the electronic transmission and either passes the payment information into the financial institution network such as an Automated Clearing House (ACH) network for payment or, alternatively, the processing center may print checks therein. User 10 generally takes the form of a business which processes and makes payments to vendors.

User 10 may generate payments through an accounting software package 12 which may take the form of several types of commercial off the shelf (COTS) software applications (e.g. QUICKEN, PEACHTREE, DACEASY, GREAT PLAINS, SAP, SQL, CA, etc.). By accepting output generated from most commercial accounting applications, a large number of users are able to utilize the features of the present invention. In the present invention, the user receives recorded invoices and bills that require attention. These commercial accounting software applications may reside on various hardware platforms such as mainframe computers, mini computers, micro computers, including UNIX and PC based systems.

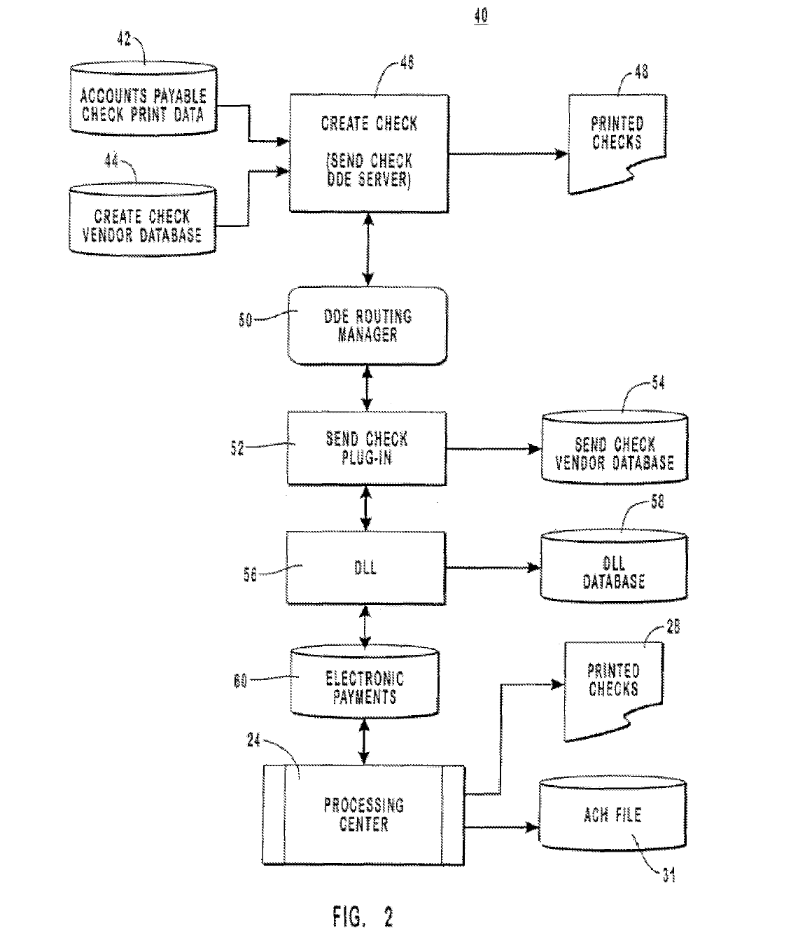

Accounting software 12 generates payment data that is read by software 14 of the present invention. The output generated by accounting software 12 generally takes the form of ASCII text data that includes but is not limited to invoice information, check date, check amount, check number, vendor number, vendor name and vendor address data. Software 14 reads the print data that accounting software 12 generates and determines whether a payment is to be made electronically or by paper. A create check process 16 determines whether a payment will be processed electronically or printed by a printer by matching vendor numbers or names in the print run with vendors in a send check vendor data base 54 (FIG. 2) which is part of send check process 18. It should be pointed out that in one embodiment of the present invention, the user has the ability to change the payment method for any of the vendors during a specific check run.

If a specific payment is designated for printing, create check process 16 directs the output to a printer 20 for the generation of printed checks 22. Create check process 16 accepts the payment data from accounting software 12 and merges this data into a predetermined form along with magnetic ink character recognition (MICR) characters and electronic images to create a laser printed check. Create check process 16 is capable of printing checks on a large number of differing types of MICR-capable printers. All the data (e.g. payment, forms, MICR, encrypted signatures and logos) is processed together to produce a laser printed check in a single pass through a desktop laser printer. In addition to a supported-type printer, other required items include MICR toner and approved check stock.

If a payment is designated for electronic processing, send check process 18 processes the payment and generates the appropriate information in an electronic payment file. Send check process 18 reads the payment data generated from accounting software 12 and designates specific items of the information for formation of the electronic payments. Items include, but are not limited to remittance data, invoice numbers, dates, descriptions, amounts, check date, number, amount, and payee name and address. Once all electronic payments are formatted into the appropriate electronic format, the user electronically transmits the data to an electronic payment processing center 24.

Electronic payment processing center 24 receives the electronic payment transmissions and processes the payments. A typical electronic payment process center 24 includes such entities as Checkfree, Electronic Data Systems (EDS), Visa Interactive as well as other electronic payment processing capable centers. Electronic payment processing center 24 reads the electronic payment file and determines whether a vendor (i.e. recipient of payments) is capable of accepting electronic payments. If a particular vendor is not electronic-capable, a printed check 28 is generated by printer 26 and mailed to the vendor by electronic payment processing center 24 as opposed to being mailed by user 10.

If the vendor is electronic-capable, an electronic transfer process 30 creates an entry in a ACH file 31 for posting to the vendor's account through a network such as a financial institution 32. Included with the ACH payment entry passed to financial institution 32 is additional remittance information (e.g. invoice number and data) supporting the particular payment. Electronic payments are created in a standard ACH format that is specified by the banking industry. Following the creation of an entry in the ACH file 31, the file is forwarded on to the ACH network (e.g. financial institution 32 and a bank network 34) for processing.

Financial institutions 32 are part of an established network capable of processing ACH items. If an institution is financial EDI (Electronic Data Interchange) capable, the remittance data will be passed along with the payment data. Otherwise, only the payment information is passed from institution to institution for posting to the appropriate accounts. Bank network 34 is an established vehicle for deposits and withdrawals between financial institutions and their customers and handles the transactions relating to the ACH items. ACH file 31 is transferred to an appropriate financial institution for processing. The payment is routed through bank network 34 and is deposited in a vendor bank account 36.

FIG. 2 is a flow diagram depicting the various modules involved in the electronic payment process, in accordance with a preferred embodiment of the present invention. In flow chart 40, a determination is made as to whether a payment is to be routed electronically to a processing center or printed into a paper check. As described in FIG. 1, accounting software generates accounts payable check print data 42 for processing by the present invention. If data 42 is not in a consistent format, preprocessing may be performed on data 42 to transform the data into a consistent format usable by the present invention. Preprocessing may be as simple as searching data 42 for form feed characters at the end of each page to make the number of lines consistent or preprocessing may be additionally complex such as involving the search for certain patterns of data with variations dependent upon other pieces of data to determine the line spacing of each check. A sample output is depicted below.

Sample output:

| Vendor ID: PR421 | | | |
|---|---|---|---|
| Feb. 14, 1997 4701 | Equip rental | 21-5004 | 3750.00 |

| | |
|---|---|
| Oct. 22, 1997 1 | 3750.00 |

Pay: ************Ten thousand seven hundred fifty dollars and no cents

| | |
|---|---|
| Oct. 22, 1997 | 87105 $******3,750.00 |

Power Rents
2550 SW 72nd Avenue
Tigard, OR 97056

A create check vendor data base 44 is a data base of vendor information such as a vendor ID and other vendor information. A create check/send check dynamic data exchange (DDE) server 46 reads the print data presented from accounts payable check print data 42. A routing manager may be used at step 50 and then a send check plug-in 52 tries to match each vendor in the print check data to a vendor in a send check vendor data base 54. Send check vendor data base 54 is comprised of information such as an ID, name, address line 1, address line 2, city, state, zip code, telephone number, account number, internal number, Soundex matching string, modified flag electronic flag, full match flag, add flag, delete flag, confirmation number and status, among others. Vendors capable of electronic payment are initially established in send check vendor data base 54.

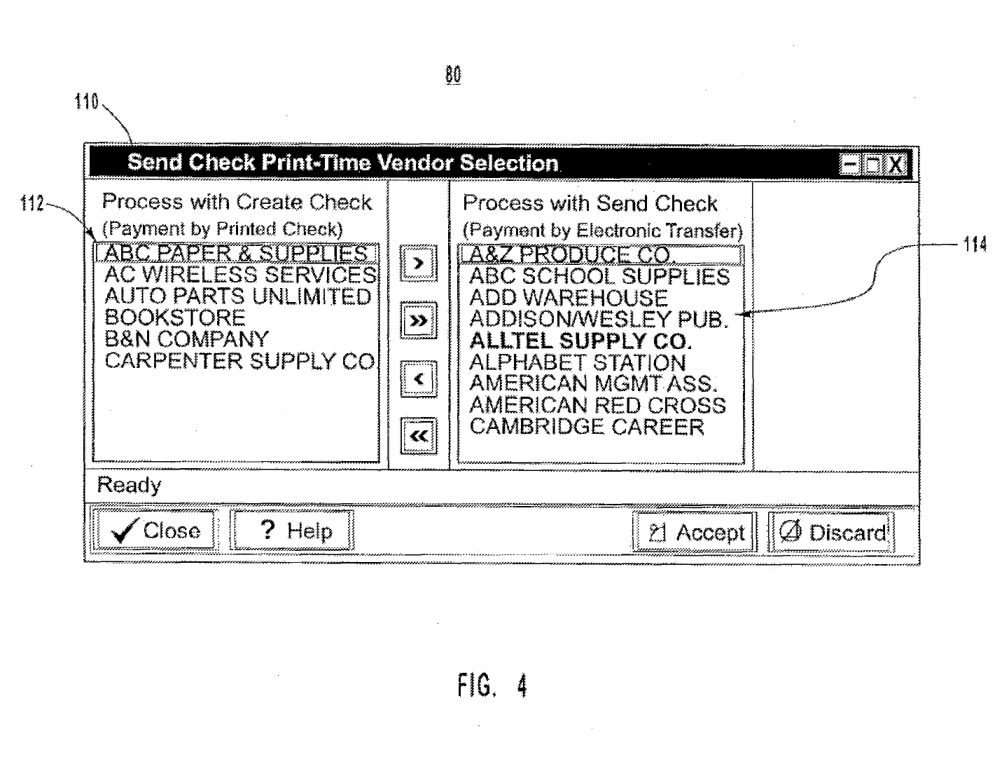

In the present invention, vendor matching is accomplished by comparing the vendor number/ID (for example, PR421 in the above example) or vendor name (for example, Power Rents in the above example) and the print data to the vendor records in send check vendor data base 54. If a vendor number/ID is present in the print data, an exact match is required. If a vendor selection screen (FIG. 4) is displayed, the user has the ability to make changes for specific payments for that run. After all changes and modifications have been made, the user continues processing. If a vendor match was discovered, the payment is passed into the electronic dynamic link library (DLL) 56 and a payment record is created in the electronic DLL data base 58. DLL data base 58 may maintain a different format for each of the different processing centers while the data bases may minimally contain items such as vendor name, vendor address, check amount, check number, check date, remittance (invoice) information and account number.

If no match is produced, the payment is deemed a paper check and is printed on a printer 48. In an alternate DOS environment, the create check print engine outputs PCL (Printer Control Language) data. This is the language used by Hewlett Packard's laser jet printers and many other HP emulated printers. In a windows environment, the output is directed to the windows printing system and the output is controlled by windows.

When a check run is complete, an electronic payments file 60 includes all transactions that are to be paid electronically. Electronic payments file 60 is transmitted via established communications to a processing center 24. Information in the electronic payment records include vendor name and address, vendor ID, check number, check amount, check date, account number, invoices numbers, invoice descriptions, invoice dates and invoice amounts.

Processing center 24 receives electronic payments file 60 and processes the payments for all of the center's customers. Processing center 24 attempts to set up each vendor as an electronic capable vendor as each new vendor is transmitted to the center. Once the vendor has been set up, all future payments are sent electronically. Until a vendor is designated as an electronic-capable vendor, payments to that vendor are printed into printed checks and sent by mail. If the vendor is not an established electronic vendor with a processing center, a printed check 28 is mailed to the vendor. If the vendor is an established electronic vendor, an ACH payment entry is created in an ACH file 31 which is sent through the ACH network on a periodic basis such as a daily basis for posting to the vendor's bank accounts.

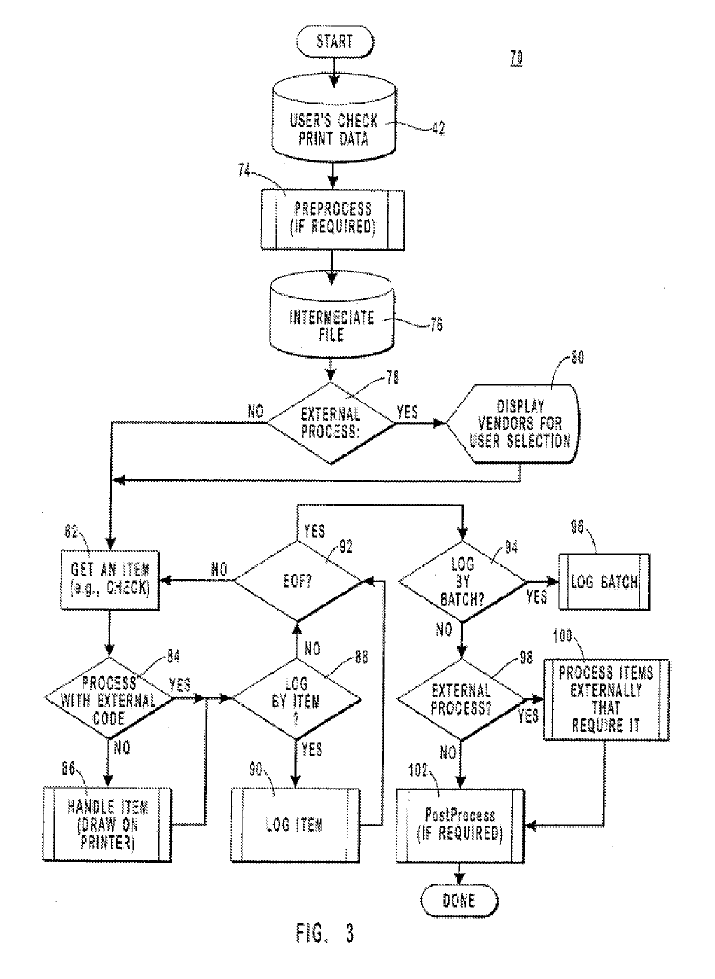

FIG. 3 is a detailed flow chart of a payment process through the payment system 70, in accordance with a preferred embodiment of the present invention. A user's check print data 42, as described in FIG. 2, is generated from commercial accounting software 12 (FIG. 1) and is generally represented in an ASCII format. When data 42 is not in a format compatible with the desired structure of the present invention, a preprocess 74 conditions the data into a desirable format usable by the present invention. Such preprocessing massages the data into a consistent format recognizable by the print engine of the present invention. A recognizable sample input format is depicted below.

| | | | | | | |
|---|---|---|---|---|---|---|
| 003 | | | | | 00000044 | 1 |
| 0 | 080294 4194980 | 2.32 | .00 | 2.32 | | |

| 3 | JOHN HENRY | 00002 |
|---|---|---|
| 1 | 2981 WEST IBM PLACE | |
| 1 | SUITE 2300 | |
| 1 | BUILDING A | 9/26/94 |

| | |
|---|---|
| 1 | SALT LAKE CITY, UT 84102-1045 |

| | |
|---|---|
| 2 | 2.32 |

| 018 | TOTAL- | 2.32 | | 2.32 | |
|---|---|---|---|---|---|
| 024 | 08 02 94 4294980 | | 2.32 | .00 | 2.32 |

| | | | |
|---|---|---|---|
| 1 | TOTAL | 2.32 | 2.32 |

| | | | |
|---|---|---|---|
| 041 | 00000044 | 00002 | 1 |
| 047 | | | 00002 |
| 051 | | | 9/26/94 |

| | |
|---|---|
| 3 | *********2 AND 32/100 US DOLLARS ***********2.32* |

| | |
|---|---|
| 2 | JOHN HENRY |
| 1 | 2981 WEST IBM PLACE |
| 1 | SUITE 2300 |
| 1 | BUILDING 1 |
| 1 | SALT LAKE CITY, UT 84102-1045 |

Is converted to:

| | | | | | | |
|---|---|---|---|---|---|---|
| | | | | 00000044 | 00002 | 1 |
| 080294 4194980 | 2.32 | .00 | 2.32 | | | |

| | |
|---|---|
| JOHN HENRY | 00002 |
| 2981 WEST IBM PLACE | |
| SUITE 2300 | |
| BUILDING A | 9/26/94 |

| | | | | SALT LAKE CITY, UT 84102-1045 | | |
|---|---|---|---|---|---|---|
| | | | | | | 2.32 |
| TOTAL- | 2.32 | | | 2.32 | | |
| 08 02 94 4194980 | | 2.32 | .00 | | 2.32 | |

| | |
|---|---|
| 0000044 | 00002 1 |
| | 00002 |
| | 9/26/94 |

| | |
|---|---|
| *********2 AND 32/100 US DOLLARS | *********2.32* |

JOHN HENRY
2981 WEST IBM PLACE
SUITE 2300
BUILDING A
SALT LAKE CITY, UT 84102-1045

This file is then in a consistent format that the create check print process can use.

Following the preprocessing of data 42, an intermediate file 76 is generated that is used for printing. Intermediate file 76 may vary in format based upon the application generating the print file, and preprocessing involved, specific mapping and interface methods and the desired output.

A query task 78 makes a determination of whether a payment should be processed electronically or if the data should be manipulated prior to printing. A vendor selection screen (FIG. 4) is displayed in a process 80 indicating the current method of payment for each vendor in the current print run. The user has the ability to redirect a payment to an alternative method of payment at this stage of the process if desired.

As each item is processed the item is logged into an encrypted file for future reporting if the system is configured to log by item as determined by a query task 88. If the system is configured to log by batch mode as determined by query task 94, there is an entry made in log file 96 at the completion of the print run. This file is encrypted for security purposes and helps reduce the possibility of data manipulation. This file is used for auditing purposes and record keeping of print jobs. Elements contained in the log file may include data and time of printing, user I.D., account I.D., beginning check number, ending check number, amount of check, payee and type of check.

If the user requests special processing after payments have been produced, a post process step 102 is executed to perform these requirements. An example of a post process program is a program that reads the check print data and formats another file that is used for uploading to another application. If in the query task 98 a send check module such as a plug in module is present and there were electronic payments generated, the user connects in a task 100 to the processing center for transmission of items and a receipt of information which may include e-mail, previous payment status, billing status as well as other status information.

FIG. 4 is a diagram which depicts a vendor selection screen 110 that is presented to the user when the send check external plug in module is present. Screen 110 depicts how each payment will be made, that is to say whether a payment will be made via a printed check or via an electronic payment process. The send check module uses an exact match based on the vendor number/I.D. field or a sound matching algorithm on the vendor name field to make the determination whether a payment will be made electronically or otherwise. The user in a previous step set up electronic vendors in the send check vendor database for matching during the print process. If send check determines the vendor is an exact match, the vendor name is displayed differently than those vendor names that only closely match a vendor name in the vendor database. When no match or no close match is detected from the vendor database, the vendor name appears in a distinct manner such as a distinct color alerting the user to employ additional scrutiny in evaluating the correctness of the spelling of the vendor name. Once all changes have been made and payments verified, the checks are processed according to the methods indicated, either electronically or in a printed check manner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-7. (canceled)

8. A system configured to electronically initiate payment of an amount owed to a vendor from a customer computer system regardless of whether the vendor utilizes an electronic payment technology for receipt of amounts owed to the vendor, the system comprising:
a local customer computer system comprising:
an electronic accounting application configured to generate print data;
electronic payment print data generated by and transmitted from the electronic accounting application;
a payment print data reader electronically coupled to the electronic accounting application that automatically receives the electronic payment print data and preprocess the electronic payment print data, wherein the payment print data reader includes
a determining module that determines a manner of effectuating the payment regardless of whether the vendor utilizes an electronic payment through an electronic payment technology when available and through a printed check when no electronic payment technology is available, the determining module comprising a send check vendor database;
a check printing module; and
an electronic payment processing module wherein if the payment is to be made electronically the local electronic payment processing module further comprises a mechanism that is configured to merge the electronic print data into a predetermined electronic payment file format that is sent directly to a remote third-party electronic payment processing center to selectively transmit an electronic payment file thereto for the payment of the amount owed to the vendor, wherein the electronic payment file is generated by the local electronic payment processing module; and
a storage device coupled to the electronic accounting application that is configured to maintain all formats used by any payment processing center; and
the remote third-party electronic payment processing center electronically coupled to the customer computer system via a communication mechanism, wherein the remote third-party electronic payment processing center is configured to receive the electronic payment file and to effectuate the payment of the amount owed to the vendor regardless of whether the vendor utilizes an electronic payment through electronic payment technology when available and through a printed check when no electronic payment technology is available.

9. The system as recited in claim 8, wherein the payment print data reader is further electronically coupled to a printing device for processing a printed check to effectuate the payment of the amount owed to the vendor when the remote third-party electronic payment processing center is not utilized.

10. The system as recited in claim 8, further comprising an entry in an automated clearing house (ACH) file based on the electronic payment file to effectuate the payment of the amount owed to the vendor when electronic payment technology is available.

11. The system as recited in claim 10, further comprising a system of a financial institution having a financial account corresponding to the vendor for receipt of the payment, wherein the system of the financial institution is electronically coupled to the remote third-party electronic payment processing center to receive the ACH file.

12. The system as recited in claim 8, wherein the electronic payment file comprises remittance data, an invoice number, an invoice date, an invoice description, an invoice amount, a check date, a check number, a check amount, a payee name, and a payee address.

13. The system as recited in claim 12, wherein the electronic payment file includes information from the electronic print data, and wherein the electronic print data is in an American standard code for information interchange (ASCII) text data format.

14. An electronic payment processing system for use in initiating payment of an amount owed to a vendor from a local electronic payment processing module of a customer computer system regardless of whether the vendor or a financial institution of the vendor employs electronic payment processing technology for receipt of amounts owed to the vendor or financial institution, the electronic payment processing system comprising:
a local customer computer system comprising:
(i) an electronic accounting application configured to generate print data;
(ii) electronic payment print data generated by and transmitted from the electronic accounting application;
(iii) a storage device coupled to the electronic accounting application that is configured to maintain all formats used by any payment processing center; and
(iv) a local electronic payment processing module electronically coupled to:
(a) the electronic accounting application, wherein the electronic payment processing module is configured to receive the electronic payment print data transmitted from the electronic accounting application and read the electronic payment print data through the use of a print data reader of the local electronic payment processing module, wherein the local electronic payment processing module includes:
(1) a module to preprocess the transmitted electronic payment print data;
(2) a module to determine a manner to effectuate the payment of the amount owed regardless of whether an electronic payment technology is used for receipt of the payment;
(3) a check printing module; and
(4) an electronic payment processing module, wherein if the payment is to be made electronically the local electronic payment processing module is configured to merge the electronic print data into a predetermined electronic payment file format that is sent directly to a remote third-party electronic payment processing center;
(b) the remote third-party electronic payment processing center to selectively transmit an electronic payment file thereto for the payment of the amount owed to the vendor, wherein the electronic payment file is generated by the local electronic payment processing module; and
(c) a printing device for automatically processing a printed check to effectuate the payment of the amount owed to the vendor when the local electronic payment processing module automatically determines not to utilize the remote third-party electronic payment processing center for effectuating the payment of the amount owed to the vendor.

15. The system as recited in claim 14, further comprising an entry in an automated clearing house (ACH) file based on the electronic payment file to automatically effectuate the payment of the amount owed to the vendor corresponding to an invoice received from the vendor.

16. The system as recited in claim 14, wherein the electronic payment file comprises remittance data, an invoice number, an invoice date, an invoice description, an invoice amount, a check date, a check number, a check amount, a payee name, and a payee address.

17. The system as recited in claim 16, wherein the electronic payment file includes information from the electronic print data, and wherein the electronic print data is in an American standard code for information interchange (ASCII) text data format.
